(19) United States
(12) Patent Application Publication
(10) Pub. No.: US 2024/0363060 A1
(43) Pub. Date: Oct. 31, 2024

(54) DISPLAY PANEL AND DISPLAY DEVICE

(71) Applicant: BOE Technology Group Co., Ltd., Beijing (CN)

(72) Inventors: Dejiang ZHAO, Beijing (CN); Wei HUANG, Beijing (CN)

(73) Assignee: BOE Technology Group Co., Ltd., Beijing (CN)

(21) Appl. No.: 18/768,018

(22) Filed: Jul. 10, 2024

Related U.S. Application Data
(63) Continuation of application No. PCT/CN2023/085431, filed on Mar. 31, 2023.

(51) Int. Cl. G09G 3/32; H04B 10/116; H04B 10/50

(52) U.S. Cl. CPC G09G 3/32; H04B 10/116; H04B 10/502; G09G 2370/16; G09G 2370/18

(57) ABSTRACT

A display panel includes a plurality of sub-pixels, and the sub-pixels include at least one first light-emitting device: a first base substrate including a first area, the plurality of sub-pixels are located in the first area; a device layer including a plurality of first light-emitting devices; a first driving unit and a second driving unit, wherein the first driving unit is used for output a driving current, and the second driving unit is used to generate an oscillating current in response to the driving current output by the first driving unit and output it to the first light-emitting device, and control the first light-emitting device to repeatedly turn on or off, so that the first light-emitting device emits a light signal while displaying.

### CROSS-REFERENCE TO RELATED APPLICATION

The present application is a continuation application of International Application No. PCT/CN2023/085431, filed on Mar. 31, 2023, and the entire contents thereof are incorporated herein by reference.

### TECHNICAL FIELD

The present disclosure relates to the field of display technology, and in particular, to a display panel and a display device.

### BACKGROUND

Visible light communication (VLC) is also known as Li-Fi. Li-Fi has higher bandwidth and higher efficiency than Wi-Fi. The spectrum bandwidth of visible light is 10,000 times that of the current electromagnetic wave bandwidth, so the bandwidth of a single data channel of Li-Fi can be very high, and it can also accommodate more channels for parallel transmission, the wireless transmission speed will therefore not be affected when multiple devices are online at the same time.

Information disclosed in the background portion is provided only for better understanding of the background of the present disclosure, and thus it may contain information that does not form the prior art known by those ordinary skilled in the art.

### SUMMARY

The purpose of this disclosure is to provide a display panel, a manufacturing method thereof, and a display device.

According to a first aspect of the present disclosure, a display panel is provided, including a plurality of sub-pixels, a single sub-pixel including at least one first light-emitting device: the display panel further includes:
a first base substrate, including a first area, wherein the plurality of sub-pixels are disposed in the first area;
a device layer, disposed on a side of the first base substrate, including a plurality of the first light-emitting devices; and
a first driving unit and a second driving unit, wherein the second driving unit is connected to the first driving unit and the first light-emitting device, the first driving unit is configured to output a driving current, and the second driving unit is configured to generate an oscillating current in response to the driving current output by the first driving unit, and output the oscillating current to the first light-emitting device, to control the first light-emitting device to repeatedly turn on or off, and to cause the first light-emitting device to emit a light signal while display.

According to a second aspect of the present disclosure, a method for manufacturing display panel is provided, including:
providing a first base substrate including a first area and a second area located at a periphery of the first area;
forming a first driving unit and a second driving unit; and
forming a device layer, the device layer is disposed on a side of the first base substrate and includes a plurality of first light-emitting devices, and the first light-emitting devices are located in the first area;
wherein, the second driving unit is connected to the first driving unit and the first light-emitting device, the first driving unit is configured to output a driving current, and the second driving unit is configured to generate an oscillation current in response to the driving current output by the first driving unit, and output the oscillating current to the first light-emitting device, to control the first light-emitting device to repeatedly turn on or off, and to cause the first light-emitting device to emit a light signal while display.

According to a third aspect of the present disclosure, a display device is provided, including the display panel according to the first aspect.

It is to be understood that both the foregoing general description and the following detailed description are exemplary and explanatory only and are not restrictive of the present disclosure.

### BRIEF DESCRIPTION OF THE DRAWINGS

The above and other features and advantages of the present disclosure will become more apparent by describing in detail example embodiments thereof with reference to the accompanying drawings.

FIG. 1 is a schematic diagram of the principle of optical communication in related technologies;

FIG. 2 is a schematic plan view of the first base substrate in an exemplary embodiment of the present disclosure;

FIG. 3 is a schematic diagram of the planar distribution of sub-pixels and driving units of the display panel in an exemplary embodiment of the present disclosure;

FIG. 4 is a schematic diagram of the planar distribution of sub-pixels and driving units of the display panel in another exemplary embodiment of the present disclosure;

FIG. 5 is a schematic diagram of the planar distribution of sub-pixels and driving units of the display panel in another exemplary embodiment of the present disclosure;

FIG. 6 is a schematic diagram of the planar distribution of sub-pixels and driving units of the display panel in another exemplary embodiment of the present disclosure;

FIG. 7 is a schematic diagram of the planar distribution of sub-pixels and driving units of the display panel in another exemplary embodiment of the present disclosure;

FIG. 8 is a schematic diagram of the planar distribution of sub-pixels and photoelectric converters in another exemplary embodiment of the present disclosure;

FIG. 9 is a schematic diagram of the cross-sectional distribution of sub-pixels and photoelectric converters in a display panel in an exemplary embodiment of the present disclosure;

FIG. 10 is a schematic diagram of the display panel cover plate packaging in an exemplary embodiment of the present disclosure;

FIG. 11 is a schematic diagram of a display panel film packaging in an exemplary embodiment of the present disclosure;

FIG. 12 is a schematic diagram of the cross-sectional distribution of sub-pixels in a display panel in an exemplary embodiment of the present disclosure;

FIG. 13 is a schematic cross-sectional distribution diagram of photoelectric converters in a display panel in an exemplary embodiment of the present disclosure;

FIG. 14 is a schematic cross-sectional view of a display panel in another exemplary embodiment of the present disclosure;

FIG. 15 is a schematic diagram of the peripheral structure of the photoelectric converter in an exemplary embodiment of the present disclosure;

FIG. 16 is a schematic structural diagram of the first light-emitting device connected to the first driving backplane in an exemplary embodiment of the present disclosure;

FIG. 17 is a schematic structural diagram of the photoelectric converter connected to the first driving backplane in an exemplary embodiment of the present disclosure;

FIG. 18 is a schematic structural diagram of the first light-emitting device connected to the first driving backplane in another exemplary embodiment of the present disclosure;

FIG. 19 is a schematic structural diagram of a photoelectric converter connected to a second driving backplane in an exemplary embodiment of the present disclosure.

The reference symbols of the main components in the figure are as follows:

100—first base substrate; 110—first area; 111—first sub-area; 112—second sub-area; 120—second area; 200—first driving layer; 201—first lead; 202—second leads; 203—third lead; 204—fourth lead; 205—active layer; 206—first gate insulating layer; 207—first gate metal layer; 208—second gate insulating layer; 209—second gate metal layer; 210—interlayer dielectric layer; 211—source and drain metal layer; 212—first planarization layer; 213—transfer layer; 214—second planarization layer; 300—cover plate; 301—barrier dam; 302—first barrier dam; 303—second barrier dam; 304—support structure; 400—encapsulation layer; 500—second base substrate; 501—n well; 502—p well; 503—first doped region; 504—second doped region; 505—gate insulating layer; 506—gate layer; 507—first planarization layer; 508—source and drain layer; 509—second planarization layer; 510—transfer layer; 511—third planarization layer; 10—sub-pixel; 11—first light-emitting device; 12—second light-emitting device; 21—first driving unit; 22—second driving unit; 23—third driving unit; 24—fourth driving unit; 30—first driving chip; 31—second driving chip; 32—third driving chip; 33—fourth driving chip; 34—first peripheral control chip; 35—second peripheral control chip; 40—photoelectric converter; 41—signal shielding layer; 42—covering layer; 43—first covering layer; 44—second covering layer; 45—arc-shaped groove.

### DETAILED DESCRIPTION

Example embodiments will now be described more fully with reference to the accompanying drawings. Example embodiments may, however, be embodied in various forms and should not be construed as limited to the examples set forth herein; rather, these embodiments are provided so that this disclosure will be thorough and complete and will fully convey the concepts of the example embodiments to those skilled in the art. The described features, structures or characteristics may be combined in any suitable manner in one or more embodiments. In the following description, numerous specific details are provided to provide a thorough understanding of embodiments of the present disclosure.

In the drawings, regions and layer thicknesses may be exaggerated for clarity. The same reference numerals in the drawings represent the same or similar structures, and thus their detailed descriptions will be omitted.

The described features, structures or characteristics may be combined in any suitable manner in one or more embodiments. In the following description, numerous specific details are provided to provide a thorough understanding of embodiments of the present disclosure. However, those skilled in the art will appreciate that the technical solutions of the present disclosure may be practiced without one or more of the specific details described, or other methods, components, materials, etc. may be employed. In other instances, well-known structures, materials, or operations are not shown or described in detail to avoid obscuring the main technical ideas of the disclosure.

When a structure is “on” another structure, it may mean that the structure is integrally formed on the other structure, or that the structure is “directly” placed on the other structure, or that the structure is “indirectly” placed on the other structure through another structure.

The terms “a”, “an” and “the” are used to indicate the existence of one or more elements/components/etc.; the terms “include” and “have” are used to indicate an open-ended inclusive meaning and refer to that there may be additional elements/components/etc. in addition to those listed. The terms “first” and “second” etc. are used merely as labels and not as quantitative limitations to their objects.

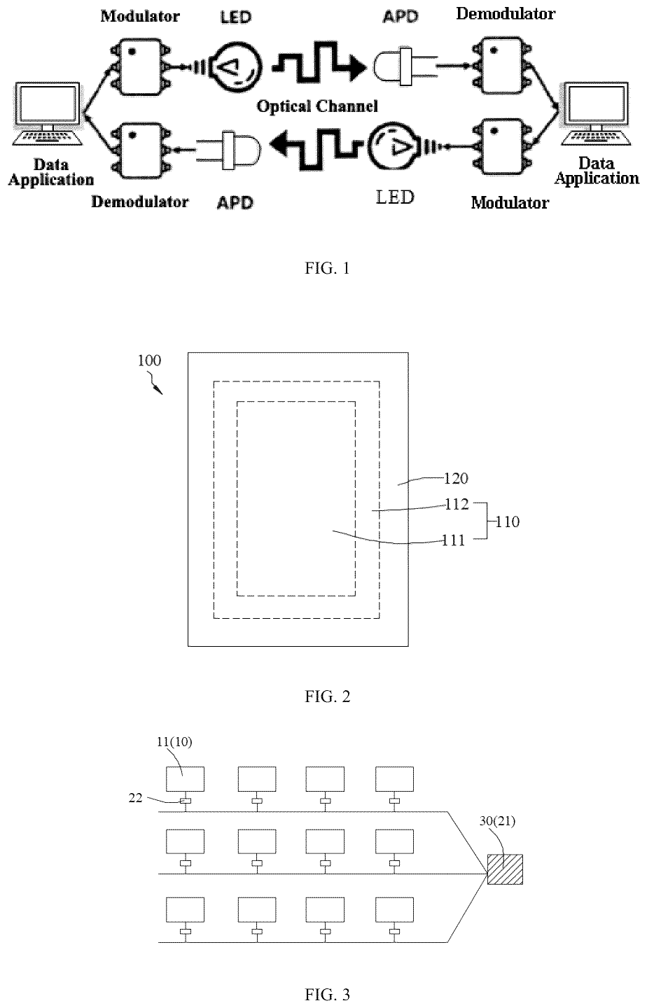

Visible light wireless communication is a wireless light transmission data technology that uses light sources. By controlling the light-emitting device to flash at a frequency of millions of times per second, with on indicating 1 and off indicating 0. Since the flashing frequency is too high, the human eye cannot detect it. Only the photoelectric converter can detect these changes. Therefore, the communication mechanism of transmitting signal by the light-emitting device while receiving signal by the photosensitive sensor is formed. The schematic diagram of visible light wireless communication is shown in FIG. 1. The data signal sent by the sending end is transmitted to the light-emitting device, such as an LED, after passing through the modulator. The light-emitting device converts the received data signal (electrical signal) into a light signal and then emits it. A light receiver, such as an APD (avalanche diode), receives the light signal and converts the light signal into an electrical signal, which is then transmitted to the receiving end via a modulator and the like.

In the related technology, a light-emitting device can be used as the sending end of wireless communication to emit data, and the receiving end can receive data through a photoelectric converter. However, the sender has a single function.

As shown in FIGS. 2 and 3, the present disclosure provides a display panel including a plurality of sub-pixels 10, and a single sub-pixel 10 includes at least one first light-emitting device 11. The display panel also includes a first base substrate 100, a device layer, a first driving unit 21 and a second driving unit 22, wherein the first base substrate 100 includes a first area 110 and a second area 120 located on the periphery of the first area 110. A plurality of sub-pixels 10 are located in the first area 110; the device layer is provided on a side of the first base substrate 100 and includes a plurality of first light-emitting devices 11. The second driving unit 22 is connected to the first driving unit 21 and the first light-emitting device 11. The first driving unit 21 is used to output a driving current. The second driving unit 22 is used to generate an oscillation current in response to the driving current output by the first driving unit 21, and output the oscillation current to the first light-emitting device 11, controlling the first light-emitting device 11 to repeatedly turn on or off, so that the first light-emitting device 11 emits a light signal while displaying.

In the display panel provided by the present disclosure, a single sub-pixel 10 includes at least one first light-emitting device 11. The second driving unit 22 is connected to the first driving unit 21 and the first light-emitting device 11. The first driving unit 21 is used to output a driving current. The second driving unit 22 is used to generate an oscillating current in response to the driving current output by the first driving unit 21 and output it to the first light-emitting device 11, to control the first light-emitting device 11 to repeatedly turn on or off, so that the first light-emitting device 11 emits a light signal while displaying. This display panel integrates display and signal transmission into one. It can not only be used to display images, but also can be used as a signal source to emit light signals and use light signals for communication. It has multiple functions and can meet the needs of insufficient applications.

Each component of the display panel provided by the present disclosure will be described in detail below with reference to the drawings and specific embodiments:

As shown in FIG. 2 and FIG. 3, the display panel provided by the present disclosure includes a plurality of sub-pixels 10, a first driving unit 21 and a second driving unit 22. The plurality of sub-pixels 10 may be arranged in an array. A single sub-pixel 10 includes at least one first light-emitting device 11. The first light emitting device 11 may be OLED, micro LED, mini LED, etc. Preferably, the first light-emitting device 11 is a micro LED.

The second driving unit 22 connects the first driving unit 21 and the first light-emitting device 11, and the first driving unit 21 is used to output a driving current. The second driving unit 22 is used to generate an oscillating current in response to the driving current output by the first driving unit 21 and output it to the first light-emitting device 11, to control the first light-emitting device 11 to repeatedly turn on or off, so that the first light-emitting device 11 emits a light signal while displaying. Specifically, the driving current output by the first driving unit 21 is used to control the lighting and gray scale of the first light-emitting device 11 for the displaying of the first light-emitting device 11. When the first driving unit 21 delivers a driving current that can light up the first light-emitting device 11, the second driving unit 22 will be activated and generate an oscillating current under the driving current. The frequency of the oscillating current is very high, which can cause the first light-emitting device 11 to turn on (lights up) and turns off quickly, but cannot be detected by the human eye, and it is still a normal display screen visually. In this normal display screen, the first light-emitting device 11 emits a bright and dark flashing visible light signal under the action of the oscillating current. This bright and dark flashing visible light signal can transmit data information and realize visible light communication.

The second driving unit 22 may be an oscillation circuit, and the frequency of the oscillation current generated thereby is not less than 10⁵ Hz. The second driving unit 22 may be used to control the switching frequency of the first light-emitting device 11, and the second driving unit 22 may control the switching frequency of the first light-emitting device 11 to be no less than 10⁵ Hz. In some embodiments of the present disclosure, the second driving unit 22 includes components such as coils, resistors, capacitors, etc., and may also include transistors, etc. The transistor can be a thin film transistor (TFT) or a metal oxide semiconductor field effect transistor (MOS). Generally, using different types of transistors can enable the first light-emitting device 11 to achieve different switching frequencies. For example, using thin film transistors, the switching frequency of the first light-emitting device 11 can reach 10⁶˜10⁸ Hz, which is very high and helps to obtain a higher signal transmission rate.

As shown in FIGS. 3 to 8, the first driving unit 21 and the second driving unit 22 can be disposed at different positions of the display panel in different ways. The arrangement of the first driving unit 21 and the second driving unit 22 will be described in detail below in conjunction with the film layer structure of the display panel.

In this disclosure, the first driving unit 21 and the second driving unit 22 may be distributed in the first area 110 or may be connected to the display panel by being integrated in a chip or distributed in the second area 120.

As shown in FIGS. 3, 4, 16, and 18, in some embodiments of the present disclosure, the second driving unit 22 is located in the first area 110. Specifically, the display panel further includes a first driving layer 200 disposed on a side of the first base substrate 100. The first driving layer 200 and the first base substrate 100 can be combined to form a first driving backplane. The first driving layer 200 includes a second driving unit 22 located in the first area 110. The first light-emitting device 11 is located on the side of the first driving layer 200 away from the first base substrate 100; the number of the second driving units 22 is multiple, and in the direction perpendicular to the first base substrate 100, the first light-emitting device 11 is arranged in one-to-one correspondence with the second driving unit 22. That is, each first light-emitting device 11 is connected to one second driving unit 22, and the second driving unit 22 provides oscillating current to the first light-emitting device 11 in a one-to-one correspondence.

The first driving unit 21 is used to control the lighting and gray scale of the first light-emitting device 11. In such embodiments, the first light-emitting device 11 may adopt a passive driving, active driving or semi-active driving mode to perform display.

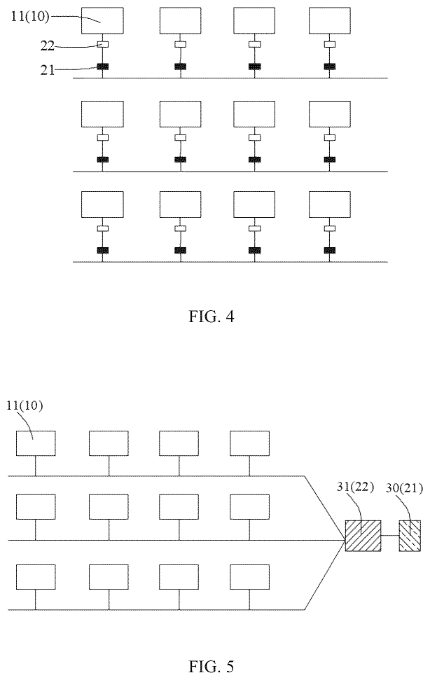

Specifically, in an embodiment, as shown in FIG. 4, the first light-emitting device 11 may adopt active driving or semi-active driving. In this embodiment, the first driving layer 200 further includes a first driving unit 21 located in the first area 110; the number of the first driving units 21 is multiple, and in the direction perpendicular to the first base substrate 100, the first light-emitting device 11 and the first driving unit 21 are arranged in one-to-one correspondence.

The first driving unit 21 includes a transistor, a capacitor and other component. Alternatively, the transistor may be a thin film transistor (TFT) or a metal oxide semiconductor field effect transistor (MOS).

Taking the transistors included in the first driving unit 21 and the second driving unit 22 being thin film transistors as an example, in terms of film layer structure, the thin film transistors can be top gate thin film transistors or bottom gate thin film transistors, which is not limited in this disclosure. In terms of thin film transistor materials, the thin film transistor can be an amorphous silicon thin film transistor, a low temperature polysilicon thin film transistor, or an oxide thin film transistor, which is not limited in this disclosure. In terms of the conduction conditions of the thin film transistor, the thin film transistor can be an N-type thin film transistor or a P-type thin film transistor, and the present disclosure does not limit this. In the first driving layer 200, each thin film transistor and storage capacitor may be formed of film layers such as an active layer, a gate insulating layer, a gate metal layer, an interlayer dielectric layer, and a source and drain metal layer. Wherein, the thin film transistor may include a semiconductor layer located in the active layer, a gate insulating layer, a gate electrode located in the gate metal layer, an interlayer dielectric layer, and a source and drain electrode layer located in the source and drain metal layer. The source and drain electrode layers are formed of source and drain electrodes of the thin film transistor. The semiconductor layer includes a channel region, and a source contact region and drain contact region on both sides of the channel region. The source electrode passes through the interlayer dielectric layer to connect with the source contact region, and the drain electrode passes through the interlayer dielectric layer to connect with the drain electrode. The gate electrode and channel area are isolated by the gate insulating layer. The positional relationship of each film layer can be determined according to the film layer structure of the thin film transistor. For example, the first driving layer 200 may include an active layer, a gate insulating layer, a gate metal layer, an interlayer dielectric layer, and a source and drain metal layer stacked in sequence. The thin film transistor formed in this way is a top-gate thin film transistor. For another example, the first driving layer 200 may include a gate metal layer, a gate insulating layer, an active layer, an interlayer dielectric layer, and a source and drain metal layer that are stacked in sequence. The thin film transistor thus formed is a bottom-gate thin film transistor.

As shown in FIG. 18, the first driving layer 200 may also adopt a double gate structure, that is, the gate metal layer may include a first gate metal layer 207 and a second gate metal layer 209, and the gate insulating layer may include a first gate insulating layer 206 for isolating the active layer 205 and the first gate metal layer 207, and include a second gate insulating layer 208 for isolating the first gate metal layer 207 and the second gate metal layer 209. For example, the first driving layer 200 may include an active layer 205, a first gate insulating layer 206, a first gate metal layer 207, a second gate insulating layer 208, a second gate metal layer 209, an interlayer dielectric layer 210, and a source and drain metal layer 211 that are sequentially stacked on a side of the first base substrate 100. Further, the first driving layer 200 may further include a first planarization layer 212, a transfer layer 213 and a second planarization layer 214 that are stacked in sequence in a direction away from the first base substrate 100. The first light-emitting device 11 may be connected to the source and drain metal layer 211 through the transfer layer 213.

As shown in FIG. 3, in another embodiment, the first light-emitting device 11 may adopt passive driving. In this embodiment, the display panel further includes a first driving chip 30, and the first driving unit 21 is integrated in the first driving chip 30. As shown in FIG. 16, in this embodiment, the first driving layer 200 includes a plurality of leads in addition to the driving unit 22. The first driving chip 30 is connected to each of the first light-emitting devices 11 and each of the second driving units 22 through the leads. For example, the first driving layer 200 further includes a wiring layer, and the wiring layer may be provided on a side of the second driving unit 22 away from the first base substrate 100. The lead layer may include a first lead 201 and a second lead 202. The first lead 201 may be connected to the first electrode of the first light-emitting device 11, and the second lead 202 may be connected to the second electrode of the first light-emitting device 11. Further, the second driving unit 22 can be connected to the first light-emitting device 11 through the first lead 201 or the second lead 202, and the first driving chip 30 can be connected to the first light-emitting device 11 through the first lead 201 or the second lead 202, or can be connected to the second driving unit 22 through the first lead 201 or the second lead 202. The specific connection method can be configured according to actual needs and is not specifically limited here. In addition, the first driving layer 200 may also include multiple lead layers, and two adjacent lead layers are separated by an insulating layer. Multiple leads can be distributed on different lead layers. For example, the first driving layer 200 further includes a first lead layer, an insulating layer and a second lead layer that are sequentially stacked in a direction away from the first base substrate. The first lead layer can be disposed on a side of the second driving unit 22 away from the first base substrate 100. The first lead layer includes a plurality of first leads 201, and the second lead layer includes a plurality of second leads 202. Similarly, the first lead 201 may be connected to the first electrode of the first light-emitting device 11, and the second lead 202 may be connected to the second electrode of the first light-emitting device 11. The second driving unit 22 can be connected to the first light-emitting device 11 through the first lead 201 or the second lead 202, and the first driving chip 30 can be connected to the first light-emitting device 11 through the first lead 201 or the second lead 202, or can be connected to the second driving unit 22 through the first lead 201 or the second lead 202. The specific connection method can be configured according to actual needs and is not specifically limited here.

The first driving chip 30 may be located on the periphery of the first base substrate 100 and connected to the first base substrate 100 through a connection structure. The first driving chip 30 is also disposed on the first base substrate 100, for example, the first driving chip 30 is located in the second area 120.

As shown in FIGS. 5 to 8, in other embodiments of the present disclosure, the second driving unit 22 is not located in the first area 110. In such embodiments, the first driving unit 21 may not be located in the first area 110, that is, the first light-emitting device 11 adopts passive driving.

As shown in FIGS. 5 and 16, in one embodiment, the display panel includes a first driving layer 200, a first driving chip 30 and a second driving chip 31, wherein the first driving layer 200 is provided on a side of the first base substrate 100, the first driving layer 200 includes a plurality of leads. The first driving unit 21 is integrated into the first driving chip 30, and the second driving unit 22 is integrated into the second driving chip 31. The first driving chip 30 and the second driving chip 31 are connected to each first light-emitting device 11 through a lead. For example, in this embodiment, the first driving layer 200 includes a lead layer, the lead layer may include a first lead 201 and a second lead 202, and the first lead 201 may be connected to the first electrode of the first light emitting device 11, the second lead 202 may be connected to the second electrode of the first light-emitting device 11. Further, the second driving chip 31 may be connected to the first light-emitting device 11 through the first lead 201 or the second lead 202. The first driving chip 30 can be connected to the first light-emitting device 11 through the first lead 201 or the second lead 202. Of course, the first driving layer 200 may also include multiple lead layers, and an insulation layer is provided between two adjacent lead layers. Connection vias can be provided in the insulating layer to connect some leads in different lead layers to each other.

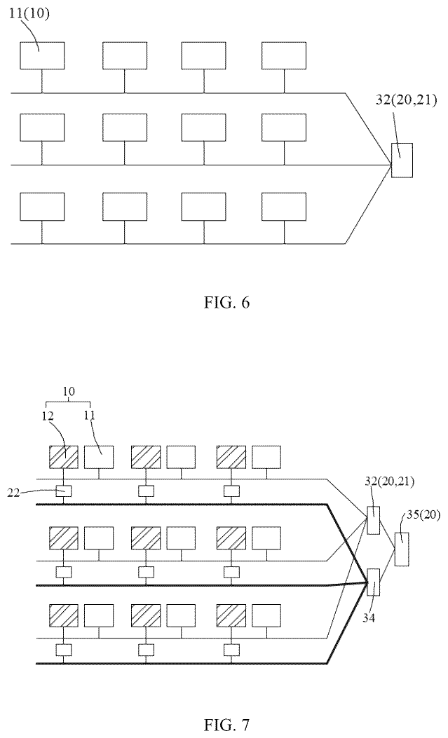

As shown in FIGS. 6 and 16, in another embodiment, the display panel includes a first driving layer 200 and a third driving chip 32. The first driving layer 200 is provided on a side of the first base substrate 100. The first driving layer 200 includes a plurality of leads. The first driving unit 21 and the second driving unit 22 are integrated into the third driving chip 32, and the third driving chip 32 is connected to each first light-emitting device 11 through the leads. For example, in this embodiment, the first driving layer 200 includes a lead layer, the lead layer may include a first lead 201 and a second lead 202, the first lead 201 may be connected to the first electrode of the first light emitting device 11, and the second lead 202 may be connected to the second electrode of the first light-emitting device 11. Further, the driving chip may be connected to the first light-emitting device 11 through the first lead 201 or the second lead 202. Of course, the first driving layer 200 may also include multiple lead layers, and an insulation layer is provided between two adjacent lead layers. Connection vias can be provided in the insulating layer to connect some leads in different lead layers to each other.

As shown in FIGS. 2 and 7, in other embodiments of the present disclosure, a single sub-pixel 10 may also include a second light-emitting device 12 in addition to the first light-emitting device 11. The device layer includes the second light emitting device 12. The second light emitting device 12 may be OLED, micro LED, mini LED, etc. In such embodiments, the display panel further includes a third driving unit 22 and a control unit 20. The third driving unit 22 is connected to the second light-emitting device 12. The third driving unit 22 is used to output a driving current to the second light-emitting device 12. The control unit 20 is connected to the first driving unit 21 and the third driving unit 22 and is used to control the first light-emitting device 11 to emit light signals within one frame displayed by the second light-emitting device 12.

The driving current output by the third driving unit 22 is used to control the lighting and gray scale of the second light-emitting device 12 to use the second light-emitting device 12 for display. In such embodiments, the second light-emitting device 12 can be driven by active driving or passive driving. Preferably, the second light-emitting device 12 can be driven by active driving to ensure the stability of the display image on the display panel. Taking the second light-emitting device 12 using active driving as an example, the first driving layer 200 further includes a third driving unit 22, and the third driving unit 22 is located in the first area 110. There are multiple third driving units 22, and the second light-emitting devices 12 and the third driving units 22 are arranged in one-to-one correspondence in the direction perpendicular to the first base substrate 100. The third driving unit 22 includes a transistor, a capacitor and other components. Alternatively, the transistor may be a thin film transistor (TFT) or a metal oxide semiconductor field effect transistor (MOS). For example, the third driving unit 22 may be a TFT compensation circuit, such as an 8T2C pixel circuit. In 8T2C, T represents the thin film transistor, C represents the capacitor, 8 and 2 represent the number of thin film transistors and capacitors respectively.

In such embodiments, the control unit 20 is connected to the first driving unit 21 and the third driving unit 22 and is used to control the first light-emitting device 11 to emit light signals within one frame displayed by the second light-emitting device 12. Specifically, the first light-emitting device 11 can be controlled to repeatedly switch on and off to emit a light signal within one frame displayed by the second light-emitting device 12. For example, within one frame displayed by the second light-emitting device 12, the number of switching times of the first light-emitting device 11 is not less than 10⁶. Normally, the frequency of the display signal of the second light-emitting device 12 can be 60˜120 HZ, and during one frame time thereof, the first light-emitting device 11 can flash 10⁸ times. Furthermore, in the same sub-pixel, when the first light-emitting device 11 emits a light signal, its brightness is the same as that of the second light-emitting device 12. Preferably, the control unit 20 can also control the first light-emitting device 11 and the second light-emitting device 12 to display synchronously.

The combination of the first light-emitting device 11 and the second light-emitting device 12 helps to emit light signals for communication while ensuring stable display of the display panel. Taking the first light-emitting device 11 as passive driving and the second light-emitting device 12 as active driving as an example, in this embodiment, the third driving unit 22 is located in the first area 110, and the first driving unit 21 and the second driving unit 22 is integrated into the third driving chip 32. Further, the display panel also includes a first peripheral control chip 34 and a second peripheral control chip 35. The first peripheral control chip 34 is connected to the third driving unit 22 and is used to transmit display signals to the second light-emitting device 12, and the control unit 20 is integrated into the second peripheral control chip 35. The second peripheral control chip 35 is connected to the first peripheral control chip 34 and the third driving chip 32, to control the first light-emitting device 11, by the first peripheral control chip 34 and the third driving chip 32, to emit light signal in one frame time of the display of the second light-emitting device 12.

It should be noted here that both the first light-emitting device 11 and the second light-emitting device 12 can be driven by active or passive devices. For example, they can be driven by active driving or passive driving at the same time, or one of them can be driven by the active driving while the other is driven by the passive driving. The control unit 20, the first driving unit 21 and the third driving unit 22 and the position distribution among them can be changed according to the different driving methods of the first light-emitting device 11 and the second light-emitting device 12, as long as the control unit 20 can control the first light-emitting device 11 to emit a light signal within one frame displayed by the second light-emitting device 12.

In the present disclosure, in addition to integrating display and emitting light signals, the display panel can also have other functions.

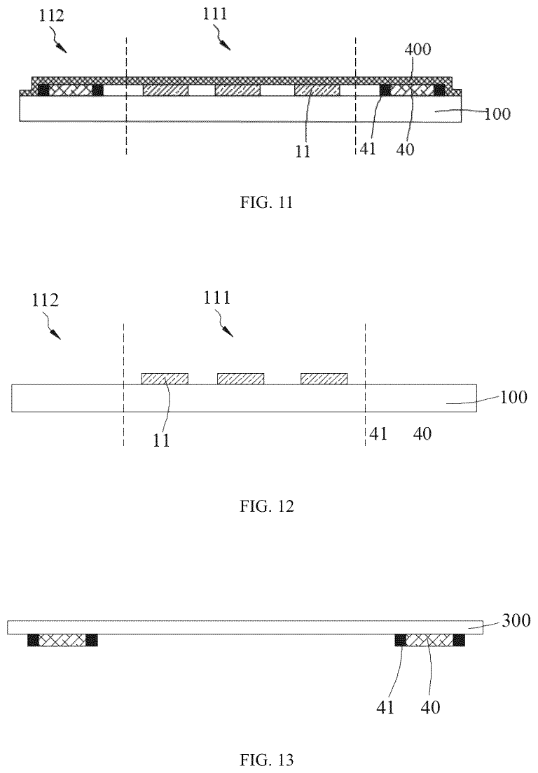

As shown in FIGS. 1, 8, and 9 to 14, in some embodiments of the present disclosure, the display panel also includes a plurality of photoelectric converters 40 for receiving light signals transmitted from the outside and converting the light signals into electrical signals for output. In such embodiments, the display panel can not only be used as a transmitting end in optical communication for transmitting light signals, but can also be used as a receiving end of optical communication for receiving light signals. The photoelectric converter 40 may include a first electrode, a first semiconductor layer, a photoelectric conversion layer, a second semiconductor layer, and a second electrode.

Photoelectric converter 40 may be a PIN diode. The first electrode may be a P electrode, correspondingly the second electrode may be an N electrode, the first semiconductor layer may be a P-type semiconductor layer, and accordingly the second semiconductor layer may be an N-type semiconductor layer. The photoelectric conversion layer may be an I (Intrinsic) semiconductor layer. When the I semiconductor layer (photoelectric conversion layer) of the PIN diode receives light of the corresponding wavelength, it generates a photocurrent. The PIN diode has high responsivity, fast response speed, wide frequency band, low operating voltage, simple bias circuit, and can withstand high reverse voltage under reverse bias, so the linear output range is wide. Its shortcomings are that the resistance of the I semiconductor layer (photoelectric conversion layer) is very large, and the output current of the diode is small, usually from a few microamps to several microamps. Therefore, in this disclosure, the PIN photodiode can be connected to a transimpedance amplifier, and after the PIN diode converts the light signal into a current signal, the transimpedance amplifier converts the current signal into a voltage signal and amplifies it to the required amplitude, which helps to improve the signal-to-noise ratio and reduce the bit error rate.

The photoelectric converter 40 may also be an APD diode, that is, an avalanche diode. Compared with PIN diodes, APD diodes further have an avalanche layer. The avalanche layer is provided between the photoelectric conversion layer and the second semiconductor layer. The avalanche layer undergoes avalanche breakdown under the action of the electric field, and the carrier energy increases and continuously collides with the crystal atoms, causing the electrons in the covalent bond to be excited to form free electron-hole pairs. The newly generated carriers again generate free electron-hole pairs through collision. This is the multiplication effect. Under the action of the multiplication effect, one carrier becomes two, and two become four, increasing like an avalanche. APD diodes utilize the avalanche multiplication effect of carriers to amplify photoelectric signals to improve detection sensitivity. Compared with PIN diodes, APD diodes further have the avalanche layer, and the photogenerated current will be amplified by this area. Therefore, ADP photodiodes have the advantages of high power and high efficiency.

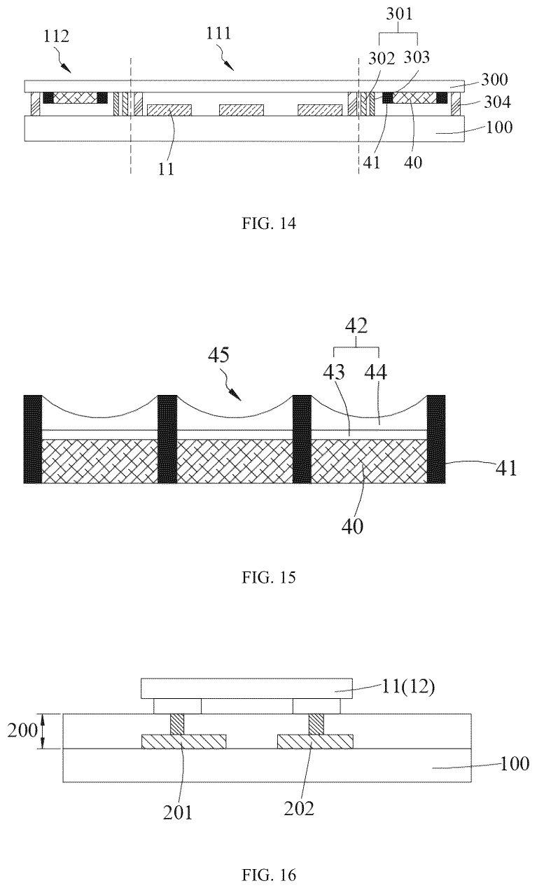

As shown in FIG. 14, the display panel further includes a signal shielding layer 41. The signal shielding layer 41 has a plurality of openings, and a plurality of photoelectric converters 40 are arranged in each opening in one-to-one correspondence. The thickness of the signal shielding layer 41 is not less than the height of the photoelectric converter 40. The signal shielding layer 41 is used to prevent ambient stray light from entering the photoelectric converter 40 and interfering with the photoelectric converter 40's reception of light signals. The material of the signal shielding layer 41 may include black resin or reflective material with reflective function.

The display panel also includes a cover layer 42, which is disposed on the side of the light-receiving surface of the photoelectric converter 40. The covering layer 42 includes a first covering layer 43 and a second covering layer 44 that are stacked sequentially in a direction away from the photoelectric converter 40. The refractive index of the first covering layer 43 is smaller than the refractive index of the second covering layer 44. The surface of the covering layer 42 away from the photoelectric converter 40 has a plurality of arc-shaped grooves 45, and the arc-shaped grooves 45 are arranged in one-to-one correspondence with the photoelectric converters 40. The covering layer 42 helps to prevent light from the side from entering the photoelectric converter 40 and interfering with the photoelectric converter 40, while the arc-shaped groove 45 at the top helps to better receive externally emitted light signals and enable evenly diffusion of the light to the entire light receiving surface of the photoelectric converter 40.

As shown in FIGS. 2 and 8, in some embodiments of the present disclosure, the display panel further includes a fourth driving unit 24 for providing a driving signal to the photoelectric converter 40. The fourth driving unit 24 may have various position distributions in the display panel. It can be located in the first area 110 of the first base substrate 100, or can be located on the periphery of the first base substrate 100 or located on the second area 120 of the first base substrate 100.

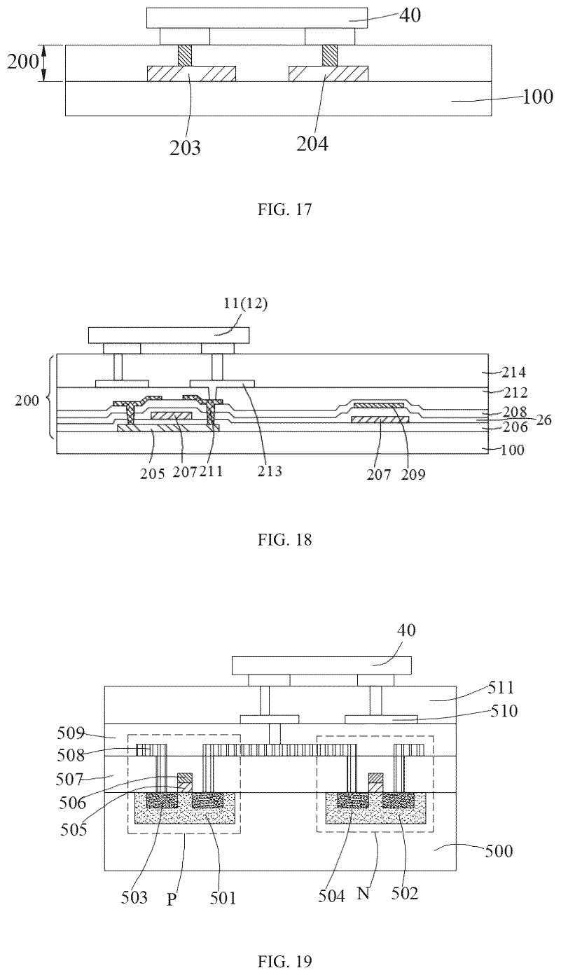

In some embodiments of the present disclosure, the fourth driving unit 24 is located at the periphery or the second area 120 of the first base substrate 100. In such embodiments, the display panel further includes a fourth driving chip 33. The fourth driving unit 24 is integrated into the fourth driving chip 33. In such embodiments, the fourth driving chip 33 may be connected to the photoelectric converter 40 through the lead in the first driving layer 200. As shown in FIG. 17, the lead layer in the first driving layer 200 also includes a third lead 203 and a fourth lead 204, wherein the third lead 203 connects the fourth driving chip 33 and the first electrode of the photoelectric converter 40, and the four leads 204 connects the fourth driving chip 33 and the second electrode of the photoelectric converter 40.

In other embodiments of the present disclosure, the fourth driving unit 24 is located in the first area 110 of the first base substrate 100. In such embodiments, the fourth driving unit 24 may be formed in the first driving layer 200. That is, when the first driving layer 200 is formed on a side of the first base substrate 100, the fourth driving unit 24 and other structures in the first driving layer 200, such as the first driving unit 21, can be formed simultaneously. In this embodiment, the first base substrate 100 may be a glass substrate or a monocrystalline silicon substrate.

In addition, the fourth driving unit 24 may also be formed separately, that is, not formed in the first driving layer 200. As shown in FIGS. 10, 11, 14, 18 and 19, for example, the display panel further includes a second driving backplane, which is provided on a side of the first base substrate 100 and located in the second sub-area 112. The second driving backplane includes a second base substrate 500 and a fourth driving unit 24 disposed on a side of the second base substrate 500. The photoelectric converter 40 is disposed on a side of the fourth driving unit 24 away from the second base substrate 500. In this embodiment, the first base substrate 100 may be a glass substrate, and the second base substrate 500 may be a monocrystalline silicon substrate.

In this embodiment, the second base substrate 500 has a p-well 502 and an n-well 501, which can be used to form N-type transistors and P-type transistors respectively. A first doped region 503 may be formed in the p-well 502. The first doped region 503 includes a source doped region and a drain doped region. A second doped region 504 may be formed in the n-well 501. The second doped region 504 includes a source doped region and a drain doped region. The second driving backplane also includes a gate insulation layer 505, a gate electrode layer 506, a first planarization layer 507 and a source and drain layer 508 that are stacked in a direction away from the second base substrate 500. The first planarization layer 507 is provided with via holes, and the source and drain layer 508 can be connected to the first doped region 503 and the second doped region 504 through the via holes. Further, the second driving backplane also includes a second planarization layer 509, a transfer layer 510 and a third planarization layer 511 provided on the side of the source and drain layer 508 away from the second complete substrate. The third planarization layer 511 and the second planarization layer 509 can also be provided with via holes, and the photoelectric converter 40 is connected to the source and drain layer 508 through the transfer layer 510.

In the present disclosure, the photoelectric converter 40 is located in the first area 110, and there may be various position distributions of the photoelectric converter 40 and the plurality of sub-pixels 10.

As shown in FIG. 8, in some embodiments, multiple photoelectric converters 40 are dispersedly located in multiple sub-pixels 10. For example, the photoelectric converters 40 and the sub-pixels 10 are alternately arranged, or every two, three, or five sub-pixels 10 are combined to form a pixel unit, and the pixel units and the photoelectric converters 40 are arranged alternately.

As shown in FIG. 2, FIG. 10, FIG. 11, and FIG. 14, in other embodiments, the first area 110 includes a first sub-area 111 and a second sub-area 112 located at the peripheral of the first sub-area 111, a plurality of sub-pixels 10 are located in the first sub-area 111, and the photoelectric converter 40 is located in the second sub-area 112. That is, the center area of the display panel is roughly the display and signal transmitting area, and the edge area is roughly the signal receiving area.

As shown in FIGS. 10 and 14, in some embodiments, the display panel further includes a barrier dam 301, which is provided on a side of the first base substrate 100 and is disposed at the peripheral of the first sub-area 111. The barrier dam 301 is located between the first sub-area 111 and the second sub-area 112 to prevent external moisture from entering and causing corrosion. The barrier dam 301 can be formed of a glue material that has the function of blocking moisture and oxygen. It not only plays the role of isolating moisture and oxygen, but also plays a connecting role. Further, the barrier dam 301 may include a first barrier dam 302 and a second barrier dam 303. The second barrier dam 303 is disposed at the peripheral of a side of the first barrier dam 302 away from the first sub-area 111. In a direction parallel to the first base substrate 100, the width of the first barrier dam 302 and the second barrier dam 303 may be 10 μm-300 μm, which may be adjusted accordingly according to the size of the display panel.

In some embodiments of the present disclosure, the display panel may be packaged using cover packaging or film packaging. As shown in FIGS. 10 and 14, in one embodiment, the display panel further includes a cover plate 300 disposed on the side of the first light-emitting device 11 and the photoelectric converter 40 away from the first base substrate 100. In this embodiment, the barrier dam 301 may be connected between the cover plate 300 and the first base substrate 100. Further, the display panel may further include a support structure 304. The support structure 304 is located between the first base substrate 100 and the cover plate 300. The height of the support structure 304 may be determined roughly based on the size of the first light-emitting device 11, the second light-emitting device 12, the optoelectronic device, and the photoelectric converter 40. For example, the size of the first light-emitting device 11 and the second light-emitting device 12 may be 10 μm-30 μm, the resolution may be 4 k˜32 k; the height of the photoelectric converter 40 may be 3 μm-10 μm, and the height of the support structure 304 may be 3 μm-15 μm.

As shown in FIG. 11, in another embodiment, the display panel further includes an encapsulation layer 400 disposed on the side of the first light-emitting device 11 and the photoelectric converter 40 away from the first base substrate 100. The orthographic projection of the first light-emitting device 11 and the photoelectric converter 40 on the first base substrate 100 is located within the orthographic projection of the packaging layer 400 on the first base substrate 100. The encapsulation layer 400 includes a first inorganic layer, an organic layer and a second inorganic layer that are sequentially stacked in a direction away from the first base substrate 100. Wherein, the first inorganic layer may be a silicon dioxide layer, a silicon nitride layer or a silicon oxynitride layer, etc., and the thickness may be 800 nm-1200 nm, such as 1000 nm. The organic layer can be an epoxy resin layer with a thickness of 5 μm-10 μm. The second inorganic layer can be a silicon dioxide layer, a silicon nitride layer, a silicon oxynitride layer, etc., with a thickness of 200 nm-500 nm, such as 300 nm.

As shown in FIGS. 2, 3, 9 to 14, the present disclosure also provides a method for manufacturing a display panel, including:

In Step S100, providing a first base substrate 100, including a first area 110 and a second area 120 located at the periphery of the first area 110;

In Step S200, forming the first driving unit 21 and the second driving unit 22; and

In Step S300, forming a device layer, wherein the device layer is provided on a side of the first base substrate 100 and includes a plurality of first light-emitting devices 11, and the first light-emitting devices 11 are located in the first area 110;
wherein, the second driving unit 22 is connected to the first driving unit 21 and the first light-emitting device 11. The first driving unit 21 is used to output a driving current, and the second driving unit 22 is used to generate an oscillating current in response to the driving current output by the first driving unit 21 and output the oscillating current to the first light-emitting device 11, to control the first light-emitting device 11 to repeatedly turn on or off, so that the first light-emitting device 11 emits a light signal while displaying.

In some embodiments of the present disclosure, the manufacturing method of the display panel further includes:

In step S400, forming a photoelectric converter 40, wherein the photoelectric converter 40 is located in the first area 110.

In the present disclosure, the first driving unit 21 and the second driving unit 22 may have multiple kinds of position distributions in the display panel. For details, please refer to any of the embodiments of the display panel mentioned above, which will not be described in detail here. Different manufacturing steps may be used for different position distributions.

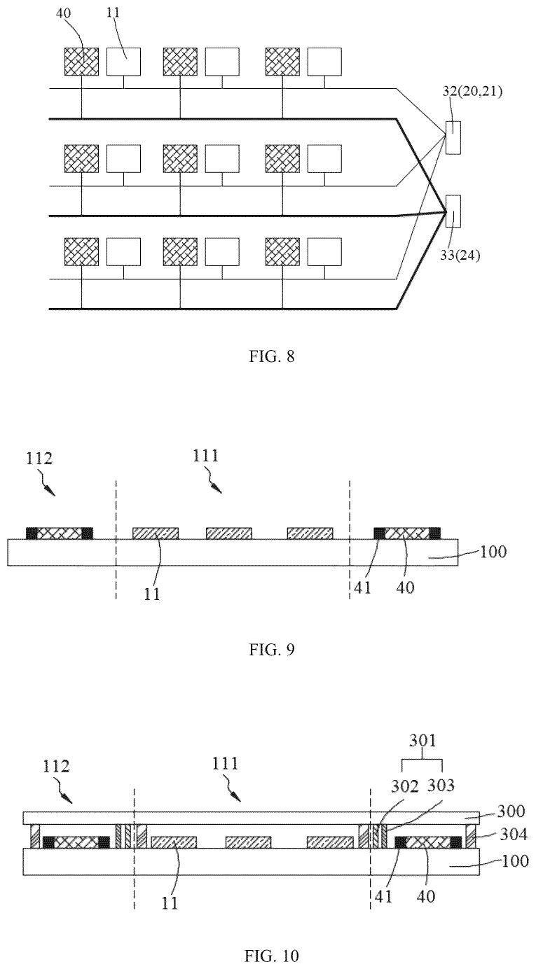

As an example, the display panel includes a first driving layer 200, and the first driving layer 200 includes a first driving unit 21 or/and a second driving unit 22. The first driving layer 200 is formed on a side of the first base substrate 100. The first driving layer 200 includes the first driving unit 21 or/and the second driving unit 22. The first base substrate 100 and the first driving layer 200 are combined to form a first driving backplane. As shown in FIGS. 9, 10 and 11, the first light-emitting devices 11 can be separately manufactured on another substrate, and then transferred to the first driving backplane by transfer printing. The first light-emitting device 11 can be a micro LED. The photoelectric converter 40 can be separately fabricated on another substrate, and then transferred to the first driving backplane by transfer printing. Of course, the photoelectric converter 40 can also be directly formed on the first driving backplane without transfer printing.

As shown in FIG. 19, taking the photoelectric converter 40 being separately fabricated on another substrate as an example, when forming the photoelectric converter 40, a fourth driving unit 24 for providing a driving signal to the photoelectric converter 40 may be formed. This step includes:

Step S410, providing a second base substrate 500;

Step S420, forming a second driving layer on a side of the second base substrate 500, where the second driving layer includes the fourth driving unit 24; and

Step S430: forming the photoelectric converter 40 on the side of the second driving layer away from the second base substrate 500.

In the embodiment, the second base substrate 500 may be a monocrystalline silicon substrate. The fourth driving unit 24 may include a transistor device, and the transistor may be a metal oxide semiconductor field effect transistor (MOS). Further, the second driving layer may also include other data processing units, such as filter circuits, to filter the electrical signals converted by the photoelectric converter 40. The second base substrate 500 has a p-well 502 and an n-well 501, which can be used to form the N-type transistor and the P-type transistor respectively. A first doped region 503 may be formed in the p-well 502. The first doped region 503 includes a source doped region and a drain doped region. A second doped region 504 may be formed in the n-well 501. The second doped region 504 includes a source doped region and a drain doped region. The second driving layer also includes a gate insulating layer 505, a gate electrode layer 506, a first planarization layer 507 and a source and drain layer 508 that are stacked in a direction away from the second base substrate 500. The first planarization layer 507 is provided with via holes, and the source and drain layer 508 can be connected to the first doped region 503 and the second doped region 504 through the via holes. Further, the second driving layer also includes a second planarization layer 509, a transfer layer 510 and a third planarization layer 511 disposed on the side of the source and drain layer 508 away from the second complete substrate. The third planarization layer 511 and the second planarization layer 509 can also be provided with vias, and the photoelectric converter 40 is connected to the source and drain layer 508 through the transfer layer 510.

In this embodiment, the second base substrate 500, the second driving layer and the photoelectric converter 40 are collectively transferred to the first driving backplane, specifically transferred to the second area 120. In the embodiment, the first base substrate 100 may be a glass substrate.

It should be noted here that when the first driving unit 21 and the second driving unit 22 are not located in the first area 110, that is, when the first driving layer 200 does not include the first driving unit 21 and the second driving unit 22, and includes only the wirings, the first light-emitting device 11 can also be separately manufactured on another substrate, and then transferred to the first driving backplane by transfer printing. The photoelectric converter 40 can also be separately fabricated on another substrate, and then transferred to the first driving backplane by transfer printing, or can be directly made on the first driving backplane without transfer printing. In the present disclosure, the first light-emitting device 11 and the photoelectric converter 40 can be connected to the corresponding driving backplane through normal mounting or flip-chipping.

In addition, as shown in FIGS. 13 and 14, in addition to being transferred to the first driving backplane, the photoelectric converter 40 can also be transferred to a cover plate 300, and then the display panel is formed by assembling the cover plate 300 and the first driving backplane.

An embodiment of the present disclosure also provides a display device, including a display panel. The display panel can be the display panel of any of the above embodiments. For its specific structure and beneficial effects, reference can be made to the above embodiments of the display panel, which will not be described again here. The display device of the present disclosure may be an electronic device such as a mobile phone, a tablet computer, or a television, which will not be listed here.

It should be noted that although the various steps of the method in the present disclosure are described in a specific order in the drawings, this does not require or imply that these steps must be performed in this specific order, or that all of the steps shown must be performed to achieve desired results. Additionally or alternatively, certain steps may be omitted, multiple steps may be combined into one step for execution, and/or one step may be decomposed into multiple steps for execution, etc., all of which shall be considered part of this disclosure.

It should be understood that the present disclosure is not limited in its application to the detailed structure and arrangement of components set forth in this specification. The disclosure is capable of other embodiments and of being implemented and carried out in various ways. The aforementioned variations and modifications fall within the scope of the present disclosure. It will be understood that the disclosure disclosed and defined in this specification extends to all alternative combinations of two or more individual features mentioned or apparent in the text and/or drawings. All of these different combinations constitute alternative aspects of the disclosure. The detailed description describes the best mode known for carrying out the disclosure, and will enable those skilled in the art to utilize the disclosure.

What is claimed is:

1. A display panel, comprising a plurality of sub-pixels, and a single sub-pixel comprising at least one first light-emitting device: the display panel further comprises:
a first base substrate, comprising a first area, wherein the plurality of sub-pixels are disposed in the first area;
a device layer, disposed on a side of the first base substrate, comprising a plurality of the first light-emitting devices; and
a first driving unit and a second driving unit, wherein the second driving unit is connected to the first driving unit and the first light-emitting device, the first driving unit is configured to output a driving current, and the second driving unit is configured to generate an oscillating current in response to the driving current output by the first driving unit, and output the oscillating current to the first light-emitting device, to control the first light-emitting device to repeatedly turn on or off, and to cause the first light-emitting device to emit a light signal while display.

2. The display panel according to claim 1, wherein a frequency of the oscillation current generated by the second driving unit is not less than 10⁵ Hz.

3. The display panel according to claim 1, further comprising:
a first driving layer, disposed on a side of the first base substrate, wherein the first driving layer comprises the second driving unit, and the second driving unit is disposed in the first area;
wherein, the first light-emitting device is located on a side of the first driving layer away from the first base substrate, and the first light-emitting device is disposed in the first area; and
the second driving unit is plural in number, and in a direction perpendicular to the first base substrate, the first light-emitting device and the second driving unit are arranged in one-to-one correspondence.

4. The display panel according to claim 3, wherein the first driving layer further comprises a first driving unit disposed in the first area;
the first driving unit is plural in number, and in a direction perpendicular to the first base substrate, the first light-emitting device and the first driving unit are arranged in one-to-one correspondence.

5. The display panel according to claim 3, wherein the display panel further comprises a first driving chip, and the first driving unit is integrated in the first driving chip; and
the first driving layer further comprises a plurality of leads, and the first driving chip is connected to the respective first light-emitting device and the respective second driving unit through the leads.

6. The display panel according to claim 1, wherein the display panel further comprises:
a first driving layer, disposed on a side of the first base substrate, wherein the first driving layer comprises a plurality of leads; and
a first driving chip and a second driving chip, wherein the first driving unit is integrated into the first driving chip, the second driving unit is integrated into the second driving chip, and the first driving chip and the second driving chip are connected to the respective first light-emitting device through the leads;
wherein, the first light-emitting device is disposed on a side of the first driving layer away from the first base substrate, and the first light-emitting device is disposed in the first area.

7. The display panel according to claim 1, wherein the display panel further comprises:
a first driving layer, disposed on a side of the first base substrate, wherein the first driving layer comprises a plurality of leads; and
a third driving chip, wherein the first driving unit and the second driving unit are integrated in the third driving chip, and the third driving chip is connected to the respective first light-emitting devices through the leads;
wherein, the first light-emitting device is disposed on a side of the first driving layer away from the first base substrate, and the first light-emitting device is disposed in the first area.

8. The display panel according to claim 1, wherein the single sub-pixel further comprises a second light-emitting device, and the device layer further comprises the second light-emitting device;
the display panel further comprises:
a third driving unit, connected to the second light-emitting device, wherein the third driving unit is configured to output a driving current to the second light-emitting device; and
a control unit, connected to the first driving unit and the third driving unit, and configured to control the first light-emitting device to emit the light signal within one frame displayed by the second light-emitting device.

9. The display panel according to claim 8, wherein within one frame of display by the second light-emitting device, the number of switching times of the first light-emitting device is not less than 10⁶.

10. The display panel according to claim 8, wherein the display panel further comprises:
a first driving layer, disposed on a side of the first base substrate, wherein the first driving layer comprises the third driving unit, and the third driving unit is disposed in the first area;
wherein, the second light-emitting device is disposed on a side of the first driving layer away from the first base substrate, and the second light-emitting device is disposed in the first area; and
the third driving unit is plural in number, and in a direction perpendicular to the first base substrate, the second light-emitting device and the third driving unit are arranged in one-to-one correspondence.

11. The display panel according to claim 1, wherein the display panel further comprises a plurality of photoelectric converters configured to receive a light signal transmitted from outside and converting the light signal into an electrical signal for output.

12. The display panel according to claim 11, wherein the display panel further comprises a signal shielding layer, the signal shielding layer has a plurality of openings, and the plurality of the photoelectric converters are disposed in each of the openings in a one-to-one correspondence; and
wherein, a thickness of the signal shielding layer is not less than a height of the photoelectric converter.

13. The display panel according to claim 11, wherein the display panel further comprises a covering layer, the covering layer is disposed on a side of a light receiving surface of the photoelectric converter;
the covering layer comprises a first covering layer and a second covering layer that are stacked sequentially in a direction away from the photoelectric converter, and a refractive index of the first covering layer is smaller than a refractive index of the second covering layer; and
a surface of the covering layer away from the photoelectric converter has a plurality of arc-shaped grooves, and the arc-shaped grooves are arranged in one-to-one correspondence with the photoelectric converter.

14. The display panel according to claim 1, wherein the display panel further comprises a plurality of photoelectric converters disposed in the first area;
wherein the plurality of the photoelectric converters are dispersedly disposed in the plurality of sub-pixels; or
the first area comprises a first sub-area and a second sub-area disposed at a periphery of the first sub-area, the plurality of sub-pixels are disposed in the first sub-area, and the photoelectric converter is disposed in the second sub-area.

15. The display panel according to claim 14, wherein when the first area comprises the first sub-area and the second sub-area disposed at the periphery of the first sub-area, and the photoelectric converter is disposed in the second sub-area, the display panel further comprises:
a barrier dam, disposed on a side of the first base substrate and surrounding the periphery of the first sub-area, wherein the barrier dam is disposed between the first sub-area and the second sub-area.

16. The display panel according to claim 14, wherein the display panel further comprises:
a cover plate, disposed on a side of the first light-emitting device and the photoelectric conversion device away from the first base substrate; or
an encapsulation layer, disposed on a side of the first light-emitting device and the photoelectric conversion device away from the first base substrate, wherein an orthographic projection of the first light-emitting device and an orthographic projection of the photoelectric conversion device on the first base substrate are located within an orthographic projection of the encapsulation layer on the first base substrate; and wherein the encapsulation layer comprises a first inorganic layer, an organic layer and a second inorganic layer that are sequentially stacked in a direction away from the first base substrate.

17. The display panel according to claim 14, wherein when the first area comprises the first sub-area and the second sub-area disposed at the periphery of the first sub-area, and the photoelectric converter is disposed in the second sub-area, the display panel further comprises:
a second driving backplane, disposed on a side of the first base substrate and disposed in the second sub-area, wherein the second driving backplane comprises a second base substrate and a fourth driving unit disposed on a side of the second base substrate, the fourth driving unit is configured to provide a driving signal to the photoelectric converter, and the photoelectric converter is disposed on a side of the fourth driving unit away from the second base substrate; and
wherein, the first base substrate is a glass substrate, and the second base substrate is a monocrystalline silicon substrate.

18. A method for manufacturing display panel, comprising:
providing a first base substrate comprising a first area and a second area located at a periphery of the first area;
forming a first driving unit and a second driving unit; and
forming a device layer, the device layer is disposed on a side of the first base substrate and comprises a plurality of first light-emitting devices, and the first light-emitting devices are located in the first area;
wherein, the second driving unit is connected to the first driving unit and the first light-emitting device, the first driving unit is configured to output a driving current, and the second driving unit is configured to generate an oscillation current in response to the driving current output by the first driving unit, and output the oscillating current to the first light-emitting device, to control the first light-emitting device to repeatedly turn on or off, and to cause the first light-emitting device to emit a light signal while display.

19. The method for manufacturing display panel according to claim 18, further comprising:
forming a photoelectric converter, wherein the photoelectric converter is disposed in the first area.

20. A display device, comprising a display panel wherein the display panel comprises a plurality of sub-pixels, and a single sub-pixel comprising at least one first light-emitting device: the display panel further comprises:
a first base substrate, comprising a first area, wherein the plurality of sub-pixels are disposed in the first area;
a device layer, disposed on a side of the first base substrate, comprising a plurality of the first light-emitting devices; and
a first driving unit and a second driving unit, wherein the second driving unit is connected to the first driving unit and the first light-emitting device, the first driving unit is configured to output a driving current, and the second driving unit is configured to generate an oscillating current in response to the driving current output by the first driving unit, and output the oscillating current to the first light-emitting device, to control the first light-emitting device to repeatedly turn on or off, and to cause the first light-emitting device to emit a light signal while display.
